(19) United States
(12) Patent Application Publication
(10) Pub. No.: US 2014/0369798 A1
(43) Pub. Date: Dec. 18, 2014

(54) SEMI-AUTOMATIC STATION FOR EXCHANGING A TRACTION BATTERY OF AN ELECTRIC OR HYBRID VEHICLE

(71) Applicant: RENAULT s.a.s., Boulogne-billancourt (FR)

(72) Inventors: Bruno Escande, Septeuil (FR); Faouzi Benachour, La Courneuve (FR)

(73) Assignee: RENAULT s.a.s., Boulogne-billancourt (FR)

(21) Appl. No.: 14/356,501

(22) PCT Filed: Nov. 6, 2012
(86) PCT No.: PCT/EP2012/071946

§ 371 Date: Jun. 11, 2014

(30) Foreign Application Priority Data
Nov. 7, 2011 (FR) 1160064

(51) Int. Cl. B60S 5/06

(52) U.S. Cl. CPC B60S 5/06; B60K 2001/0472
USPC 414/584; 414/809

(57) ABSTRACT

A device and method for exchanging a discharged traction battery (113) of an electric or hybrid vehicle (3) for a recharged traction battery (114). The device comprises means (220, 221) for aligning the vehicle on a reference dimension relative to the direction (Y) transverse to the vehicle, means (219) for aligning the vehicle on a reference dimension relative to the direction (X) longitudinal to the vehicle, vehicle lifting means (21) for raising and lowering the vehicle, means (25) for immobilising the vehicle relative to the vertical direction, lifting means for raising or lowering the means (23) for unlocking the battery from or locking the battery to the vehicle. The device further comprises handling means (115) for transporting the batteries.

The present invention relates to a semi-automatic station for exchanging a traction battery. It applies in particular to electric or hybrid vehicles.

Current electric vehicles, in particular those which use a lithium-ion battery (Li-ion) as a traction battery, still have limited autonomy which is in any case less than the autonomy of most thermal vehicles. This is a problem which the present invention is intended to solve.

In order to overcome this problem of autonomy, battery exchange stations for electric cabs have been installed since the end of the 19th century in the United States. These very first “battery exchange stations” are described in the works of David A. Kirsch published in 2000 and entitled “The electric vehicle and the burden of History”. The cabin of the cab was first raised in order to be separated from a platform which is supported by the wheels and which itself supports the electric motor and the battery thereof. Then, the discharged battery was itself raised and a recharged battery was put in its place. All these heavy handling operations involved the assistance of several operators, who raised and deposited the cabin of the cab and the batteries using lifting devices of the workshop crane or block and pulley type. A major disadvantage of these first stations was the absence of automation, which made the time required to exchange a battery very variable in accordance with the number and experience of the operators available. This is again a problem which the present invention is intended to solve.

In order to solve this problem involving the exchange time, rapid exchange stations have been proposed, such as the station described in the patent U.S. Pat. No. 5,612,606 published on 18 Mar. 1997, so that the exchange time of the battery of an electric vehicle becomes substantially equivalent to the time for filling the fuel tank of a thermal vehicle. This rapid station allows the rapid exchange of the battery of an electric vehicle comprising a traction battery which can be removed from below the vehicle. It comprises means for aligning the vehicle relative to means for lifting the battery, these means including rough lifting means which allow a first approach of the battery below the vehicle and more refined lifting means which allow the battery to be positioned precisely below the vehicle. This rapid station also comprises means for moving the batteries in one direction or the other between the lifting zone and a recharging zone. A major disadvantage of this completely automated rapid exchange station is its very high installation and maintenance costs. In fact, these costs make the station difficult to fund financially, in particular in developing countries or emerging countries where the automotive sector is restricted. This is because, in these countries, the use of a motor vehicle, whether it be thermal or electric, remains restricted to a very privileged sector of the population. Such stations can be paid for within a reasonable term only in developed countries with a very extensive automotive sector. Again, this is a problem which the present invention is intended to solve.

An object of the invention is in particular to limit the installation and maintenance costs of the exchange station, so that it can be used in a profitable manner in developing countries and in emerging countries. To this end, a main notion of the invention is to provide a semi-automatic battery exchange station for a battery which can be removed from below the vehicle and which requires the intervention of only one operator. To this end, the invention relates to a device which allows an operator to exchange a discharged traction battery of an electric or hybrid vehicle for a recharged traction battery. The device comprises, in an exchange zone, means for aligning the vehicle at a reference dimension relative to the transverse direction with respect to the vehicle, means for aligning the vehicle at a reference dimension relative to the longitudinal direction with respect to the vehicle, means for lifting the vehicle which allow the vehicle to be raised or lowered, means for immobilizing the vehicle in a reference position relative to the vertical direction, lifting means which allow means for unlocking the discharged battery from the vehicle or locking the recharged battery to the vehicle to be raised or lowered. The means for immobilizing the vehicle in a reference position relative to the vertical direction and the lifting means which allow means for unlocking or locking the battery to be raised or lowered are arranged on an exchange carriage which is capable of being installed below the vehicle by the operator. The device further comprises handling means which allow the operator to transport the discharged battery between the exchange zone and a charging zone and/or to transport the recharged battery between the charging zone and the exchange zone.

For example, the handling means may include a fork-type handling carriage.

Advantageously, the device may comprise means for suggesting to the operator where to install the exchange carriage below the vehicle.

Advantageously, the means for immobilizing the vehicle in a reference position relative to the vertical direction may include a plurality of control elements which are capable of being received by guiding elements and support elements which are arranged below the bodywork of the vehicle.

Advantageously, the lifting means which allow the means for unlocking the discharged battery from the vehicle or locking the recharged battery to the vehicle to be raised and lowered may include a lifting table.

Advantageously, the means for aligning the vehicle at a reference dimension relative to the longitudinal direction with respect to the vehicle may include at least one pair of rollers whose rotation axes may be orientated in the transverse direction with respect to the vehicle, this pair of rollers being able to be capable of receiving and stopping a wheel of the vehicle.

Advantageously, the means for aligning the vehicle at a reference dimension relative to the transverse direction with respect to the vehicle may include two guiding ramps which are arranged so that at least one of them applies a reaction force to a wheel which travels between said two ramps, and two sets of rollers whose rotation axes may be orientated in the longitudinal direction with respect to the vehicle, wherein the two sets of rollers are each able to be capable of simultaneously receiving one of the two wheels of a same train of the vehicle during travel, one of said two wheels travelling between the two guiding ramps, each of the two sets of rollers being able to allow the wheel which it receives to slide in a transverse direction with respect to the vehicle as far as a reference dimension relative to the transverse direction under the action of the reaction force applied to the wheel which travels between said two guiding ramps.

Advantageously, the means for lifting the vehicle may include a lifting platform which comprises at least two columns.

The invention also relates to a method which allows an operator to remove a discharged traction battery from an electric or hybrid vehicle and to charge it. The method comprises a step of aligning the vehicle at a reference dimension relative to the transverse direction with respect to the vehicle. It also comprises a step of aligning the vehicle at a reference dimension relative to the longitudinal direction with respect to the vehicle. It also comprises a step of lifting the vehicle using lifting means. It also comprises a step of lowering the vehicle using the lifting means in order to make the vehicle collaborate with means for immobilizing the vehicle in a reference position relative to the vertical direction. It also comprises a step of raising, using lifting means, means for unlocking the discharged battery. It also comprises a step of unlocking the discharged battery using the unlocking means. The method further comprises a step of installing, below the vehicle by the operator, an exchange carriage which supports the means for immobilizing the vehicle in the reference position relative to the vertical direction and the means for lifting means for unlocking the discharged battery, and a step of transporting the discharged battery towards a charging zone by the operator using handling means.

The invention also relates to a method which allows an operator to install a recharged traction battery in an electric or hybrid vehicle. The method comprises a step of transporting the recharged battery from a charging zone in order to deposit it on means for locking said battery. It also comprises a step of raising, using lifting means, means for locking the recharged battery and said battery. It also comprises a step of locking the recharged battery using the locking means. It also comprises a step of lowering locking means using the lifting means. It also comprises a step of raising the vehicle using the lifting means so as to release the vehicle from means for immobilizing said vehicle in a reference position relative to the vertical direction. It also comprises a step of lowering the vehicle using the lifting means. The method further comprises a step of retraction of an exchange carriage which is arranged below the vehicle by the operator, this exchange carriage supporting the means for immobilizing the vehicle in the reference position relative to the vertical direction and the means for lifting means for locking the charged battery. The step of transporting the battery is carried out by the operator using handling means.

The present invention also has the main advantage that it does not require a specific qualification from the single operator thereof, who may be trained in only a few hours in the use of an exchange station according to the invention. This is found to be particularly advantageous in developing or emerging countries in which the workforce seeking employment has for the most part few qualifications or none at all. Finally and in particular, an exchange station according to the invention is never damaging in terms of employment in one of these countries. This is because either the attendant already employed must be retrained to become an exchange station operator according to the invention, or an operator has to be employed.

Other features and advantages of the invention will be appreciated from the following description with reference to appended drawings, in which:

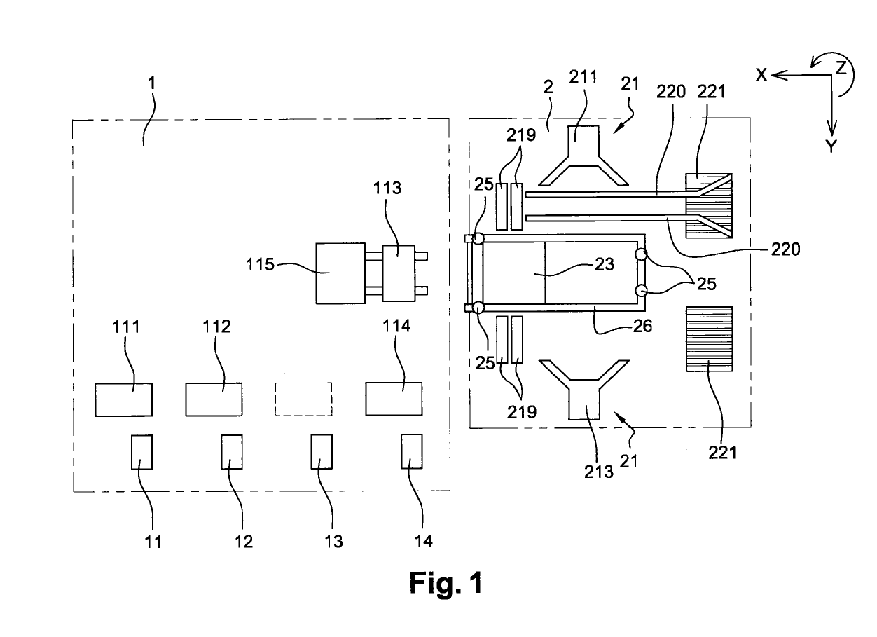

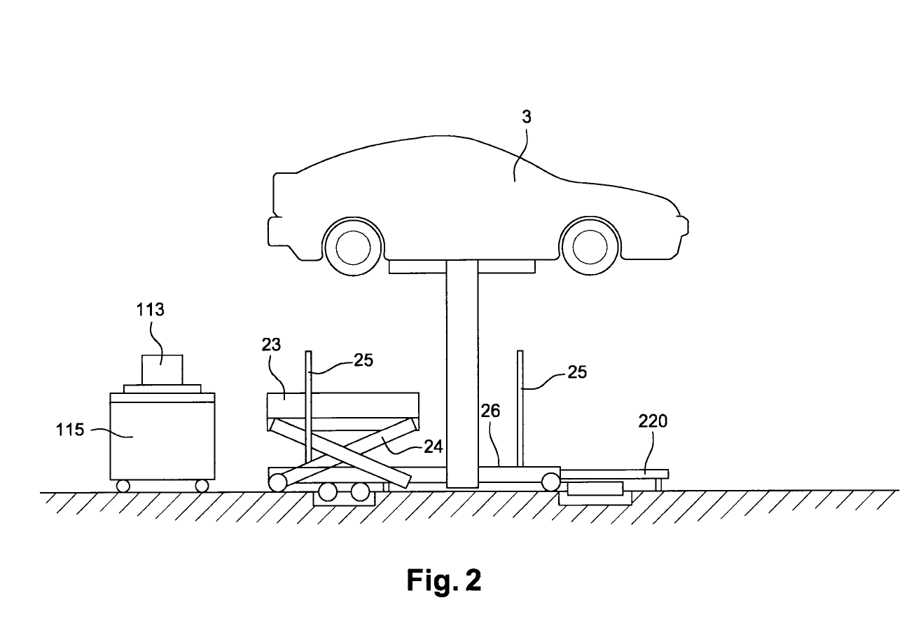

FIGS. 1 and 2 are schematic overall views of an example of a station according to the invention:

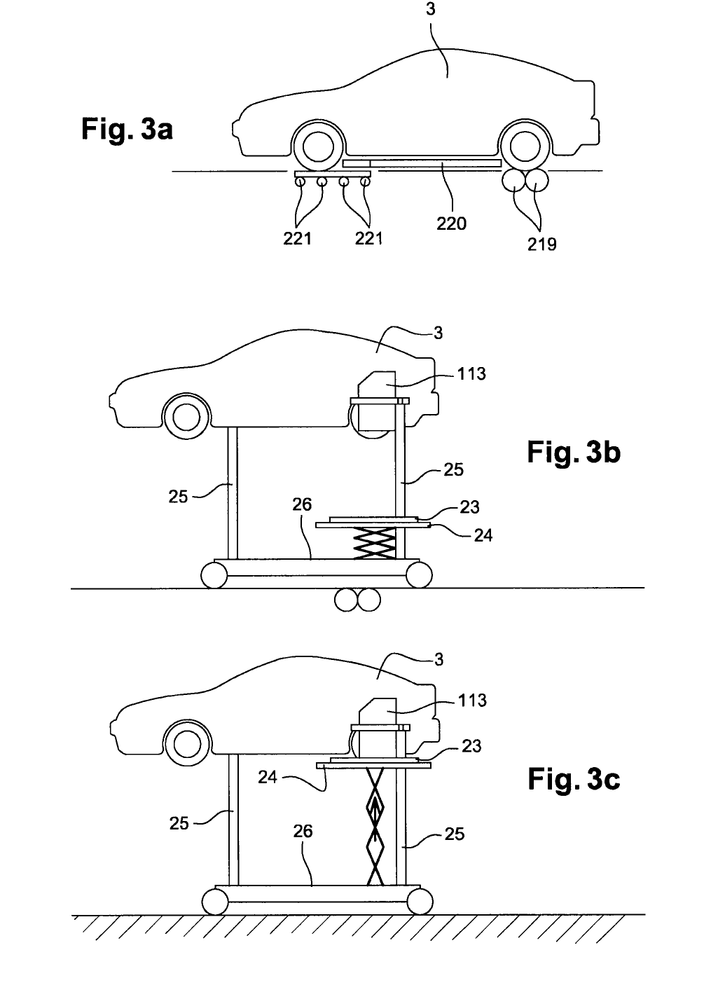

FIGS. 3a, 3b, 3c, 4a, 4b, 4c, 5a, 5b and 5c are schematic profile views of an exemplary embodiment of the method according to the invention.

FIGS. 1 and 2 are schematic views of an example of an exchange station according to the invention, comprising a storage zone 1 which is substantially 6 meters wide and 7 meters long, in order to receive four charging stations 11, 12, 13 and 14 which are capable of recharging simultaneously four traction batteries 111, 112, 113 and 114, respectively. The exchange station also comprises an exchange zone 2 which substantially has the surface-area of a motor vehicle 3 whose discharged battery 113 can be removed from below. In the exchange zone 2 there is arranged a lifting platform 21 which comprises two columns 211 and 213 which each have two lifting arms opposite each other. A fork-type handling carriage 115 allows, for example, the battery 113 to be transported, and any of the other batteries 111, 112 and 114, between the exchange zone 2 and the charging station 13 in one direction or the other.

Two sets of rollers 221 whose rotation axes are orientated in a longitudinal direction X with respect to the vehicle 3 are each capable of receiving first one of the two rear wheels of the vehicle 3 when travelling backwards, one of said two rear wheels travelling between two guiding ramps 220. The two guiding ramps 220 are arranged so that at least one of them applies a reaction force to the wheel travelling between the two ramps 220. The sets of wheels 221 thus allow the rear wheels to slide in a transverse direction Y relative to the vehicle 3 as far as a reference dimension relative to the direction Y under the action of this reaction force. The two guiding ramps 220 actually collaborate with the sets of rollers 221 in order to form a device of the “rolling correlator” type. The sets of rollers 221 are capable of receiving secondly the front wheels of the vehicle 3 and of aligning them in the same manner at this reference dimension relative to the direction Y until the vehicle 3 stops, as soon as the two pairs of rollers 219 whose rotation axes are orientated in the transverse direction Y relative to the vehicle 3 each receive and support one of the rear wheels of the vehicle 3, automatically stopping the progression thereof at a reference dimension relative to the longitudinal direction X with respect to said vehicle 3.

Once the vehicle 3 has been immobilized in a reference position in the directions Y and X, the lifting platform 21 lifts the vehicle 3 via the columns 211 and 213 thereof whose lifting arms may be supported on support zones below the vehicle 3, for example, jack support zones.

After an exchange carriage 26 mounted on three wheels has been rolled below the vehicle 3, the lifting platform lowers the vehicle 3 which is placed on four control elements 25 which are supported by the exchange carriage 26, the control elements 25 being received by guiding and support elements which are arranged below the bodywork of the vehicle 3 in order to immobilize the vehicle 3 in a substantially horizontal position at a reference dimension with respect to a vertical direction Z. Since they are arranged below the bodywork of the vehicle 3, the guiding and support elements are not visible in the present figures. In the present exemplary embodiment, the fork-type handling carriage 115 allows the discharged battery 113 to be deposited on a tool 23 or to be removed from this tool 23. The tool 23 is a dedicated tool which allows the batteries 111, 112, 113 and 114 to be locked to or unlocked from the vehicle 3. It is supported by a lifting table 24 which is also supported by the exchange carriage 26.

FIGS. 3a, 3b, 3c, 4a, 4b, 4c, 5a, 5b and 5c illustrate an example of the method according to the invention for exchanging the battery of the vehicle 3.

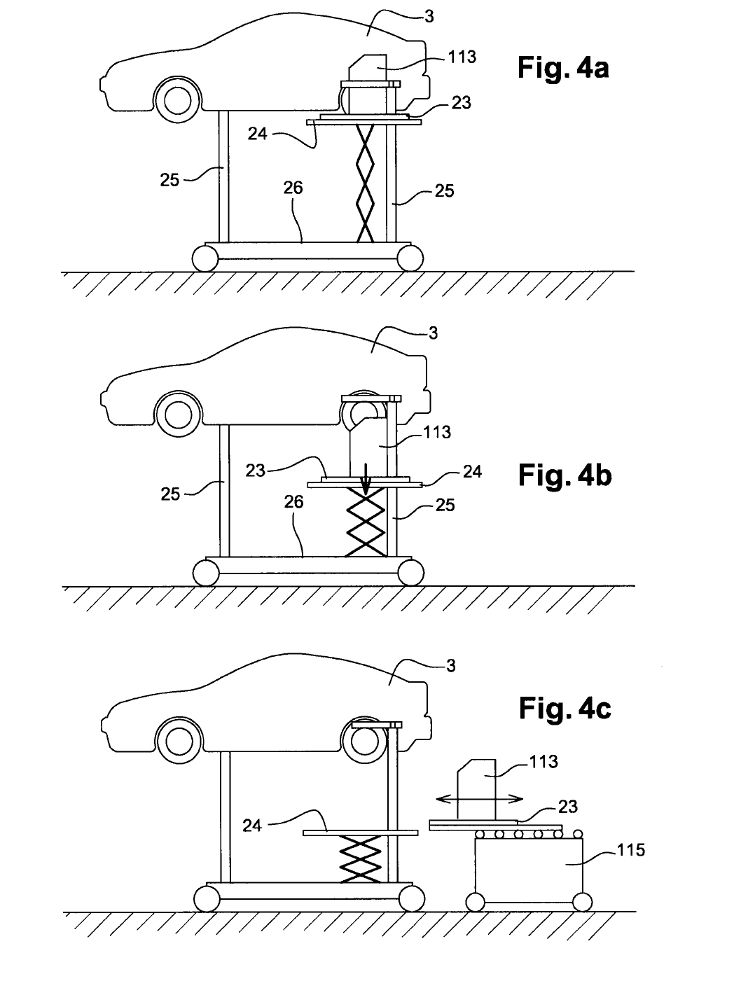

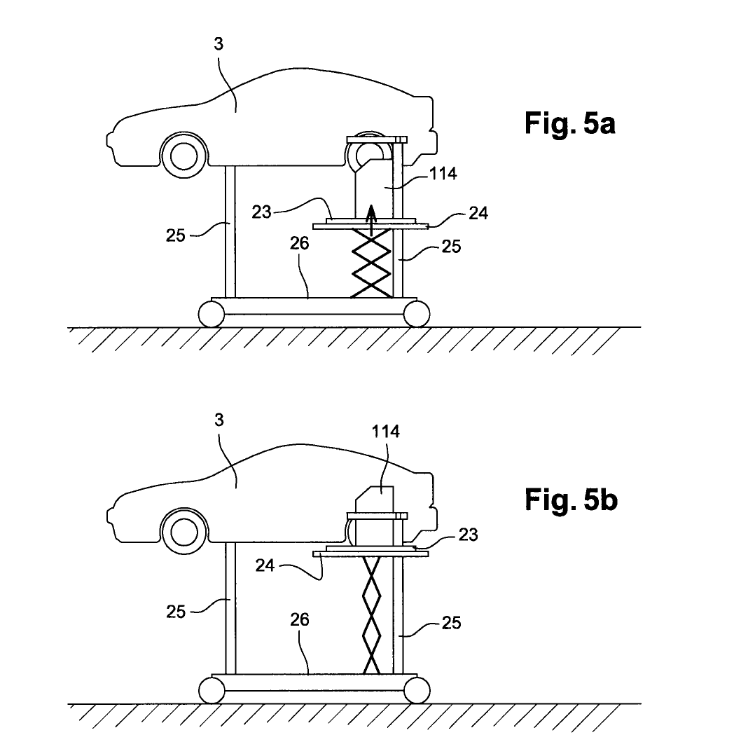

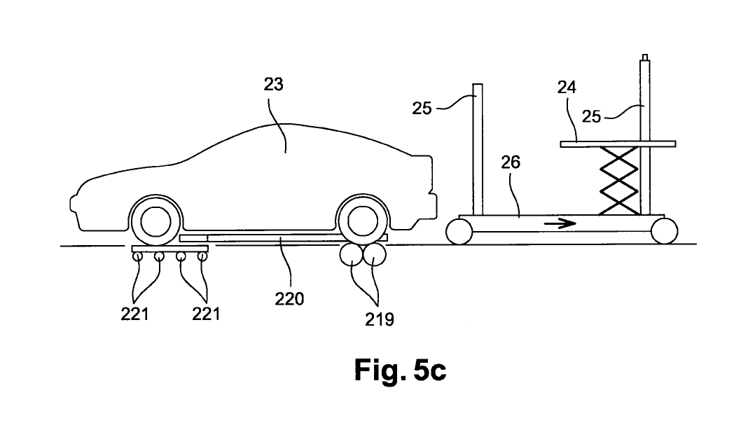

As illustrated in FIG. 3a, the vehicle 3 first moves backwards in order to successively move the rear left wheel then the front left wheel thereof between the guiding ramps 220, the two rear wheels then the two front wheels thereof sliding successively on the sets of rollers 221 in the direction Y as far as the reference dimension relative to Y. Then, the pairs of rollers 219 stop the vehicle 3 automatically via the two rear wheels thereof at the reference dimension relative to the direction X. Then, the lifting platform lifts the vehicle 3 to a height which allows an operator, not illustrated in the figures, to set the exchange carriage 26 in motion, in order to move it below the vehicle 3, for example, into a position suggested by marks painted on the ground. For example, these marks may suggest the location of each of the wheels of the exchange carriage 26. Then, as illustrated in FIG. 3b, the lifting platform 21 lowers the vehicle 3 until the four control elements 25 are in abutment against the guiding and support elements which are located below the vehicle 3, these last elements not being illustrated in the figures, thereby immobilizing the vehicle 3 in a substantially horizontal position at a reference dimension relative to the direction Z. Then, as illustrated in FIG. 3c, the lifting table 24 lifts the tool 23 until it is placed in abutment against guiding and support elements arranged below the battery 113, these last guiding and support elements also not being illustrated in the figures, the battery 113 being the battery which is almost discharged mounted on the vehicle 3 in the present exemplary embodiment of the method according to the invention. Then, as suggested in FIG. 4a, mechanisms for automatically unlocking the tool 23, these mechanisms not being the subject matter of the present application, are used in order to release the battery 113 from the vehicle 3. Embodiments of the tool are, for example, given in the International Application WO 2011/058256 A1 filed by the same Applicant. Then, as illustrated in FIG. 4b, the lifting table 24 lowers the tool 23 which supports the battery 113. Then, as illustrated in FIG. 4c, the fork-type handling carriage 115 removes the tool 23 which supports the discharged battery 113 from the lifting table 24. Then, as suggested in FIG. 5a, the fork-type handling carriage 115 returns the tool 23 which this time supports the recharged battery 114 in order to deposit it on the table 24. Then, as illustrated in FIG. 5b, the lifting table 24 lifts the tool 23 which supports the battery 114 until the battery 114 is moved into abutment against guiding, support and locking elements which are located below the vehicle 3, these last elements also not being illustrated in the figures. As suggested by FIG. 5b, mechanisms for automatically locking the tool 23, these mechanisms not being the subject matter of the present application, are then used in order to connect the battery 114 and the vehicle 3 to each other. Then, the lifting table 24 lowers the tool 23, the lifting platform 21 lifts the vehicle 3 in order to release it from the control elements 25 so that the operator can manually withdraw the exchange carriage 26 by setting it in motion. As suggested by FIG. 5c, the lifting platform 21 lowers the vehicle 3 to the ground again, the vehicle 3 being able to leave the exchange station with maximum autonomy.

1. A device for an operator to exchange a discharged traction battery of an electric or hybrid vehicle for a recharged traction battery, wherein the device comprises, in an exchange zone:
means for aligning the vehicle at a reference dimension relative to the transverse direction with respect to the vehicle;
means for aligning the vehicle at a reference dimension relative to the longitudinal direction with respect to the vehicle;
means for lifting the vehicle which allow the vehicle to be raised or lowered;
means for immobilizing the vehicle in a reference position relative to the vertical direction;
lifting means which allow means for unlocking the discharged battery from the vehicle or locking the recharged battery to the vehicle to be raised or lowered;
wherein the means for immobilizing the vehicle in a reference position relative to the vertical direction and the lifting means which allow means for unlocking or locking the battery to be raised or lowered are arranged on an exchange carriage capable of being installed below the vehicle by the operator;
wherein said device further comprises handling means which allow the operator to transport the discharged battery between the exchange zone and a charging zone and/or to transport the recharged battery between the charging zone and the exchange zone.

2. The device as claimed in claim 1, wherein the handling means include a fork-type handling carriage.

3. The device as claimed in claim 1, further comprising means for suggesting to the operator where to install the exchange carriage below the vehicle.

4. The device as claimed in claim 1, wherein the means for immobilizing the vehicle in a reference position relative to the vertical direction include a plurality of control elements capable of being received by guiding elements and support elements which are arranged below the bodywork of the vehicle.

5. The device as claimed in claim 1, wherein the lifting means which allow the means for unlocking the discharged battery from the vehicle or locking the recharged battery to the vehicle to be raised and lowered include a lifting table.

6. The device as claimed in claim 1, wherein the means for aligning the vehicle at a reference dimension relative to the longitudinal direction with respect to the vehicle include at least one pair of rollers whose rotation axes are orientated in the transverse direction with respect to the vehicle, this pair of rollers being capable of receiving and stopping a wheel of the vehicle.

7. The device as claimed in claim 1, wherein the means for aligning the vehicle at a reference dimension relative to the transverse direction with respect to the vehicle include two guiding ramps which are arranged so that at least one of them applies a reaction force to a wheel which travels between said two ramps, and two sets of rollers whose rotation axes are orientated in the longitudinal direction with respect to the vehicle, wherein the two sets of rollers are each capable of simultaneously receiving one of the two wheels of a same train of the vehicle during travel, one of said two wheels travelling between the two guiding ramps, each of the two sets of rollers allowing the wheel which it receives to slide in a transverse direction with respect the vehicle as far as a reference dimension relative to the transverse direction under the action of the reaction force applied to the wheel which travels between said two guiding ramps.

8. The device as claimed in claim 1, wherein the means for lifting the vehicle include a lifting platform which comprises at least two columns.

9. A method for an operator to remove a discharged traction battery from an electric or hybrid vehicle and to charge said battery, wherein the method comprises:
a step of aligning the vehicle at a reference dimension relative to the transverse direction with respect to the vehicle;
a step of aligning the vehicle at a reference dimension relative to the longitudinal direction with respect to the vehicle;
a step of lifting the vehicle using lifting means;
a step of lowering the vehicle using the lifting means in order to make the vehicle collaborate with means for immobilizing the vehicle in a reference position relative to the vertical direction;
a step of raising, using lifting means, means for unlocking the discharged battery;
a step of unlocking the discharged battery using the unlocking means;
a step of installing, below the vehicle by the operator, an exchange carriage which supports the means for immobilizing the vehicle in the reference position relative to the vertical direction and the means for lifting means for unlocking the discharged battery;
a step of transporting the discharged battery towards a charging zone by the operator using handling means.

10. A method for an operator to install a recharged traction battery in an electric or hybrid vehicle, wherein the method comprises:
a step of transporting the recharged battery from a charging zone in order to deposit the battery on means for locking said battery;
a step of raising, using lifting means, means for locking the recharged battery and said battery;
a step of locking the recharged battery using the locking means;
a step of lowering locking means using the lifting means;
a step of raising the vehicle using the lifting means so as to release the vehicle from means for immobilizing said vehicle in a reference position relative to the vertical direction;
a step of lowering the vehicle using the lifting means;
a step of retracting an exchange carriage arranged below the vehicle by the operator, said exchange carriage supporting the means for immobilizing the vehicle in the reference position relative to the vertical direction and the means for lifting means for locking the charged battery;
wherein the step of transporting the battery is carried out by the operator using handling means.
